(19) United States
(12) Patent Application Publication
(10) Pub. No.: US 2004/0082241 A1
(43) Pub. Date: Apr. 29, 2004

(54) Fiberglass nonwoven binder

(76) Inventor: Klein A. Rodrigues, Signal Mountain, TN (US)

Correspondence Address: NATIONAL STARCH AND CHEMICAL COMPANY, P.O. BOX 6500, BRIDGEWATER, NJ, 08807-3300, US

(21) Appl. No.: 10/606,421

(22) Filed: Jun. 26, 2003

Related U.S. Application Data
(63) Continuation-in-part of application No. 10/283,406, filed on Oct. 29, 2002.

(51) Int. Cl. B32B 27/04

(52) U.S. Cl. 442/104; 442/105; 524/245; 524/559; 524/560; 525/437; 525/444

(57) ABSTRACT

The present invention relates to a non-woven binder composition containing a copolymer having both an acid and a hydroxyl, amide or amine functionality. The invention also relates to the use of polyamines as crosslinkers for a polymer binder. The binder composition is especially useful for binding mineral fiber, and particularly as a fiberglass binder. The binder composition provides a strong, yet flexible bond, that allows a compressed fiberglass mat to easily expand once the compression is released.

This application is a continuation-in-part of U.S. patent application Ser. No. 10/283,406.

### FIELD OF THE INVENTION

The invention relates to a non-woven binder composition containing a copolymer having both an acid and a hydroxyl, amide or amine functionality. The invention also relates to the use of polyamines as crosslinkers for a polymer binder. The binder composition is especially useful for binding mineral fiber, and particularly as a fiberglass binder. The binder composition provides a strong, yet flexible bond, that allows a compressed fiberglass mat to easily expand once the compression is released.

### BACKGROUND OF THE INVENTION

Fiberglass insulation products generally consist of glass fibers bonded together by a polymeric binder. An aqueous polymer binder is sprayed onto matted glass fibers soon after they have been formed, and while they are still hot. The polymer binder tends to accumulate at the junctions where fibers cross each other, holding the fibers together at these points. The heat from the fibers causes most of the water in the binder to vaporize. An important property of the fiberglass binder is that it must be flexible—allowing the fiberglass product to be compressed for packaging and shipping, but recover to its full vertical dimension when installed.

Phenol-formaldehyde binders have been the primary binders in the manufacture of fiberglass insulation. These binders are low-cost and easy to apply and readily cured. They provide a strong bond, yet elasticity and good thickness recovery to obtain the full insulating value. One drawback to phenol-formaldehyde binders is that they release significant levels of formaldehyde into the environment during manufacture. The cured resin can also release formaldehyde in use, especially when exposed to acidic conditions. Exposure to formaldehyde produces adverse health effects in animals and humans. Recent developments have lead to reduced emissions of formaldehyde, as in U.S. Pat. No. 5,670,585, or as in a mixture of phenol formaldehyde binders with carboxylic acid polymer binders, as in U.S. Pat. No. 6,194,512, however formaldehyde emissions remain a concern.

Alternative chemistries have been developed to provide formaldehyde-free binder systems.

These systems involve three parts: 1) A polymer, such as a polycarboxyl, polyacid, polyacrylic, or anhydride; 2) A cross-linker that is an active hydrogen compound such as trihydric alcohol (U.S. Pat. No. 5,763,524; U.S. Pat. No. 5,318,990), triethanolamine (U.S. Pat. No. 6,331,350; EP 0990728), beta-hydroxy alkyl amides (U.S. Pat. No. 5,340,868; or hydroxy alkyl urea (U.S. Pat. Nos. 5,840,822; 6,140,388) and 3) A catalyst or accelerator such as a phosphorous containing compound or a fluoroborate compound (U.S. Pat. No. 5,977,232).

These alternative binder composition work well, however, there is a need for alternative fiberglass binder systems that provide the performance advantages of phenol-formaldehyde resins, in a formaldehyde-free system.

Surprisingly it has been found that a polymeric binder having both acid and hydroxyl, amide, or amine groups produces a strong, yet flexible and clear fiberglass insulation binder system. The presence of both the acid and active hydrogen functionalities within the same copolymer eliminates the need for an extra component, and also places the functional groups in close proximity for efficient crosslinking. It has also surprisingly been found that a polyamine can be used as the crosslinker for polymer binders.

### SUMMARY OF THE INVENTION

The present invention is directed to a nonwoven binder composition, having an aqueous solution comprising a copolymer binder having both an acid functionality and a hydroxyl, amide, or amine functionality.

The present invention is also directed to a nonwoven binder composition having a polyamine as a crosslinking agent.

The invention is also directed to a bonded fiberglass mat having directly deposited thereon a copolymer binder having both an acid and a hydroxyl, amide, or amine functionality.

### DETAILED DESCRIPTION OF THE INVENTION

The present invention relates to a non-woven binder composition containing a copolymer binder synthesized from at least one acid-functional monomer, and having at least one hydroxyl, amide, or amine functional monomer. It also relates to a polyamine crosslinking agent for any polymer binder.

The copolymer binder is synthesized from one or more acid monomers. The acid monomer may be a carboxylic acid monomer, a sulfonic acid monomer, a phosphonic acid monomer, or a mixture thereof. The acid monomer makes up from 1 to 99 mole percent, preferably from 50 to 95 mole percent, and most preferably from 60 to 90 mole percent of the polymer. In one preferred embodiment, the acid monomer is one or more carboxylic acid monomers. The carboxylic acid monomer includes anhydrides that will form carboxyl groups in situ. Examples of carboxylic acid monomers useful in forming the copolymer of the invention include, but are not limited to acrylic acid, methacrylic acid, crotonic acid, isocrotonic acid, fumaric acid, maleic acid, cinnanic acid, 2methylmaleic acid, itaconic acid, 2-methylitaconic acid, sorbic acid, alpha-beta-methyleneglutaric acid, maleic anhydride, itaconic anhydride, acrylic anhydride, methacrylic anhydride. Preferred monomers are maleic acid, acrylic acid and methacrylic acid. The carboxyl groups could also be formed in situ, such as in the case of isopropyl esters of acrylates and methacrylates that will form acids by hydrolysis of the esters when the isopropyl group leaves.

Examples of phosphonic acid monomers useful in forming the copolymer include, but are not limited to vinyl phosphonic acid.

Examples of sulfonic acid monomers useful in forming the copolymer include, but are not limited to styrene sulfonic acid, 2-acrylamido-2-methylpropane sulfonic acid, vinyl sulfonic acid, methallyl sulfonic acid, sulfonated styrene, and allyloxybenzenesulfonic acid.

The copolymer binder is also synthesized from one or more hydroxyl, amide, or amine containing monomers. The hydroxyl, amide, or amine monomer makes up from 1 to 75 mole percent, and preferably 10 to 20 mole percent of the copolymer. Examples of hydroxyl monomers useful in forming the copolymer of the invention include, but are not limited to hydroxy propyl (meth) acrylate, hydroxy ethyl (meth) acrylate, hydroxy butyl (meth) acrylate and methacrylate esters of poly(ethylene/propylene/butylene) glycol. In addition, one could use the acrylamide or methacrylamide version of these monomers. Monomers like vinyl acetate that can be hydrolyzed to vinyl alcohol after polymerization may be used. Preferred monomers are hydroxypropyl acrylate and methacrylate. Examples of amine-functional monomers useful in the present invention include, N, N dialkylaminoalkyl(meth) acrylate, N,N dialkylaminoalkyl (meth) acrylamide, preferably dimethylaminopropyl methacrylate, dimethylaminoethyl methacrylate, tert-butylaminoethyl methacrylate and dimethylaminopropyl methacrylamide. In addition monomers like vinyl formamide and vinylacetamide that can be hydrolyzed to vinyl amine after polymerization may also be used. Cationic monomers includes the quarternized derivatives of the above monomers as well as diallyldimethylammonium chloride, methacrylamidopropyl trimethylammonium chloride Furthermore, aromatic amine monomers such as vinyl pyridine may also be used. Other amine-containing monomers could also be polymerized into the polymer to provide the amine functionality. These include, but are not limited to sulfobetaines and carboxybetaines.

The functionalized copolymer could contain a mixture of both hydroxyl and amine functional monomers. It was found that copolymers containing lower levels of these functional monomers were more flexible than copolymers containing higher levels of these functional monomers. While not being bound to any particular theory, it is believed this may be related to the lower Tg copolymers that are formed. Amide-functional monomers could also be used to form the copolymer if a higher cure temperature is used in forming the finished non-woven.

The mole ratio of acid-functional monomer to hydroxyl-, amide, or amine-functional monomer is preferably from 100:1 to 1:1, and more preferably from 5:1 to 1.5:1.

Other ethylenically unsaturated monomers may also be used to form the copolymer binder, at a level of up to 50 mole percent based on the total monomer. These monomers can be used to obtain desirable properties of the copolymer, in ways known in the art. For example, hydrophobic monomers can be used to increase the water-resistance of the non-woven. Monomers can also be use to adjust the Tg of the copolymer to meet the end-use application requirements. Useful monomers include, but are not limited to, (meth)acrylates, maleates, (meth)acrylamides, vinyl esters, itaconates, styrenics, acrylonitrile, nitrogen functional monomers, vinyl esters, alcohol functional monomers, and unsaturated hydrocarbons. Low levels of up to a few percent of crosslinking monomers may also be used to form the polymer. The extra crosslinking improves the strength of the bonding, yet at higher levels would be detrimental to the flexibility of the resultant material. The crosslinking moieties can be latent crosslinking where the crosslinking reaction takes place not during polymerization but during curing of the binder. Chain-transfer agent may also be used, as known in the art, in order to regulate chain length and molecular weight. The chain transfer agents may be multifunctional so as to produce star type polymers.

The functionalized copolymer is synthesized by known methods of polymerization, including solution, emulsion, suspension and inverse emulsion polymerization methods. In one preferred embodiment, the polymer is formed by solution polymerization in an aqueous medium. The aqueous medium may be water, or a mixed water/water-miscible solvent system, such as a water/alcohol solution. The polymerization may be batch, semi-batch, or continuous. The polymers are typically prepared by free radical polymerization but condensation polymerization may also be used to produce a polymer containing the desired moieties. For example, copolymers of poly(aspartate-cosuccinimide) can be prepared by condensation polymerization. This copolymer can be further derivatized by alkanolamines to produce a polymer with carboxylic acid as well as hydroxyl moieties. The monomers may be added to the initial charge, added on a delayed basis, or a combination. The copolymer is generally formed at a solids level in the range of 15 to 60 percent, and preferably from 25 to 50 percent, and will have a pH in the range of from 1-5, and preferably from 2-4. One reason a pH of above 2 is preferred is for the hazard classification it will be afforded. The copolymer may be partially neutralized, commonly with sodium, potassium, or ammonium hydroxides. The choice of base, and the partial-salt formed will effect the Tg of the copolymer. The use of calcium or magnesium base for neutralization, produces partial salts having unique solubility characteristics, making them quite useful, depending on the end-use application.

The copolymer binder may be random, block, star, or other known polymer architecture. Random polymers are preferred due to the economic advantages, however other architectures could be useful in certain end-uses. Copolymers useful as fiberglass binders will have weight average molecular weights in the range of 1,000 to 300,000, and preferably in the range of 2,000 to 15,000. The molecular weight of the copolymer is preferably in the range of 2,500 to 10,000, and most preferably from 3,000 to 6,000.

The functionalized copolymer binder will form strong bonding without the need for a catalyst or accelerator. One advantage of not using a catalyst in the binder composition is that catalysts tend to produce films that can discolor, or films that release phosphorous-containing vapors. The copolymer of the present invention, used without a catalyst, forms a clear film. An accelerator or catalyst may preferentially be combined with the copolymer binder in order to decrease the time for cure, increase the crosslinking density, reduce the curing time, and/or decrease the water sensitivity of the cured binder. Catalysts useful with the binder are those known in the art including, but not limited to, alkali metal salts of a phosphorous-containing organic acid, such as sodium hypophosphate, sodium phosphite, potassium phosphite, disodium pyrophosphate, tetrasodium pyrophosphate, sodium tripolyphosphate, sodium hexametaphosphate, potassium polyphosphate, potassium tripolyphospate, sodium trimetaphosphate, sodium tertametaphosphate; fluouroborates, and mixtures thereof. The catalyst could also be a Lewis acid, such as magnesium citrate or magnesium chloride; a Lewis base; or a free radical generator, such as a peroxide. The catalyst is present in the binder formulation at from 0 to 25 percent by weight, and more preferably from 1 to 10 percent by weight based on the copolymer binder.

Optionally, additional hydroxyl, polyol, or amine components may be admixed with the copolymer binder as crosslinking agents. Since the copolymer contains internal hydroxy or amine groups, the external crosslinkers are not required. Useful hydroxyl compounds include, but are not limited to, trihydric alcohol; beta-hydroxy alkyl amides; polyols, especially those having molecular weights of less than 10,000; ethanol amines, such as triethanol amine; hydroxy alkyl urea; oxazolidone. Useful amines include, but re not limited to, triethanol amine, and polyamines having two or more amine groups, such as diethylene triamine, tetratethylene pentamine, and polyethylene imine. Preferably the polyamine contains no hydroxy groups. The polyol or amine, in addition to providing additional cross-linking, also serves to plasticize the polymer film. Other amine crosslinkers include the KYMENE amide-amine copolymers available from Hercules, and amide-amine copolymers of epichlorohydrin.

The polyamine crosslinkers can be used to crosslink both functionalized and non-functionalized polymer binders, including homopolymer binders such as polymethacrylic acid and polyacrylic acid.

The copolymer binder may optionally be formulated with one or more adjuvants, such as, for example, coupling agents, dyes, pigments, oils, fillers, thermal stabilizers, emulsifiers, curing agents, wetting agents, biocides, plasticizers, anti-foaming agents, waxes, flame-retarding agents, and lubricants. The adjuvants are generally added at levels of less than 20 percent, based on the weight of the copolymer binder.

The copolymer binder composition is useful for bonding fibrous substrates to form a formaldehyde-free non-woven material. The copolymer binder of the invention is especially useful as a binder for heat-resistant non-wovens, such as, for example, aramid fibers, ceramic fibers, metal fibers, polyrayon fibers, polyester fibers, carbon fibers, polyimide fibers, and mineral fibers such as glass fibers. The binder is also useful in other formaldehyde-free applications for binding fibrous substances such as wood, wood chips, wood particles and wood veneers, to form plywood, particleboard, wood laminates, and similar composites.

The copolymer binder composition is generally applied to a fiber glass mat as it is being formed by means of a suitable spray applicator, to aid in distributing the binder evenly throughout the formed fiberglass mat. Typical solids of the aqueous solutions are about 5 to 12 percent. The binder may also be applied by other means known in the art, including, but not limited to, airless spray, air spray, padding, saturating, and roll coating. The residual heat from the fibers causes water to be volatilized from the binder, and the high-solids binder-coated fiberglass mat is allowed to expand vertically due to the resiliency of the glass fibers. The fiberglass mat is then heated to cure the binder. Typically the curing oven operates at a temperature of from 130° C. to 325° C. The fiberglass mat is typically cured from 5 seconds to 15 minutes, and preferably from 30 seconds to 3 minutes. The cure temperature will depend on both the temperature and the level of catalyst used. The fiberglass mat may then be compressed for shipping. An important property of the fiberglass mat is that it will return to its full vertical height once the compression is removed.

Properties of the finished non-woven (fiberglass) include the clear appearance of the film. The clear film may be dyed to provide any desired color. The copolymer binder produces a flexible film, which allows the fiberglass insulation to bounce back after one unwraps the roll and uses it in walls/ceilings.

Fiberglass, or other non-woven treated with the copolymer binder composition is useful as insulation for heat or sound in the form of rolls or batts; as a reinforcing mat for roofing and flooring products, ceiling tiles, flooring tiles, as a microglass-based substrate for printed circuit boards and battery separators; for filter stock and tape stock and for reinforcements in both non-cementatious and cementations masonry coatings.

The following examples are presented to further illustrate and explain the present invention and should not be taken as limiting in any regard.

### EXAMPLE 1

A reactor containing 598.0 grams of water was heated to 94 C. A mixed monomer solution containing 309.0 grams of methacrylic acid and 7.6 grams of hydroxyethylmethacrylate was added to the reactor over a period of 3.5 hours. An initiator solution comprising of 21.2 grams of sodium persulfate in 127.5 grams of deionized water was simultaneously added to the reactor over a period of 3 hours and 50 minutes. The reaction product was held at 94 C for an additional hour.

### EXAMPLE 2

A reactor containing 598.0 grams of water was heated to 94 C. A mixed monomer solution containing 275.0 grams of methacrylic acid and 46.2 grams of hydroxyethylmethacrylate was added to the reactor over a period of 3.5 hours. An initiator solution comprising of 21.2 grams of sodium persulfate in 127.5 grams of deionized water was simultaneously added to the reactor over a period of 3 hours and 50 minutes. The reaction product was held at 94 C for an additional hour.

### EXAMPLE 3

A reactor containing 598.0 grams of water was heated to 94 C. A mixed monomer solution containing 309.0 grams of methacrylic acid and 7.6 grams of dimethylaminoethyl methacrylate was added to the reactor over a period of 3.5 hours. An initiator solution comprising of 21.2 grams of sodium persulfate in 127.5 grams of deionized water was simultaneously added to the reactor over a period of 3 hours and 50 minutes. The reaction product was held at 94 C for an additional hour. The reaction was cooled and then neutralized with ammonia solution to a pH of 7.0.

### EXAMPLE 4

A reactor containing 158.0 grams of water was heated to 94 C. A monomer solution containing 81.8 grams of methacrylic acid and 20 grams of hydroxyethylacrylate was added to the reactor over a period of 3.5 hours. An initiator solution comprising of 21.2 grams of sodium persulfate in 127.5 grams of deionized water was simultaneously added to the reactor over a period of 3 hours and 50 minutes. The reaction product was held at 94 C for an additional hour. The reaction was cooled and then neutralized with 75.2 grams of a 50% NaOH solution.

### EXAMPLE 5

A reactor containing 184.0 grams of water and 244 grams of isopropanol was heated to 85 C. A monomer solution containing 240 grams of acrylic acid and 60 grams of hydroxypropylacrylate (12.2 mole %) was added to the reactor over a period of 3.5 hours. An initiator solution comprising of 15 grams of sodium persulfate in 100 grams of deionized water was simultaneously added to the reactor over a period of 4 hours. The reaction product was held at 85 C for an additional hour. The isopropanol was then distilled using a dean Stark trap. The reaction product was then partially neutralized using 17.6 grams of ammonium hydroxide (28%) solution and 52 grams of deionized water. The polymer solution had 51% solids and a pH of 2.7.

### EXAMPLE 6

A reactor containing 184.0 grams of water and 244 grams of isopropanol was heated to 85 C.

A monomer solution containing 274 grams of acrylic acid and 26 grams of hydroxypropylacrylate (5 mole %) was added to the reactor over a period of 3.5 hours. An initiator solution comprising of 15 grams of sodium persulfate in 100 grams of deionized water was simultaneously added to the reactor over a period of 4 hours. The reaction product was held at 85 C for an additional hour. The isopropanol was then distilled using a dean Stark trap. The reaction product was then partially neutralized using 14 grams of ammonium hydroxide (28%) solution and 84 grams of deionized water. The polymer solution had 52% solids and a pH of 2.5.

### EXAMPLE 7

A reactor containing 184.0 grams of water and 244 grams of isopropanol was heated to 85 C. A monomer solution containing 240 grams of acrylic acid and 53.4 grams of hydroxyethylacrylate (12.2 mole %) was added to the reactor over a period of 3.5 hours. An initiator solution comprising of 15 grams of sodium persulfate in 100 grams of deionized water was simultaneously added to the reactor over a period of 4 hours. The reaction product was held at 85 C for an additional hour. The isopropanol was then distilled using a Dean Stark trap. The reaction product was then partially neutralized using 12 grams of ammonium hydroxide (28%) solution and 52 grams of deionized water. The polymer solution had 51% solids and a pH of 2.5.

### EXAMPLE 8

A reactor containing 184.0 grams of water and 244 grams of isopropanol was heated to 85 C. A monomer solution containing 274 grams of acrylic acid and 23.2 grams of hydroxyethylacrylate (5 mole %) was added to the reactor over a period of 3.5 hours. An initiator solution comprising of 15 grams of sodium persulfate in 100 grams of deionized water was simultaneously added to the reactor over a period of 4 hours. The reaction product was held at 85 C for an additional hour. The isopropanol was then distilled using a Dean Stark trap. The reaction product was then diluted with 84 grams of deionized water. The polymer solution had 51% solids.

### EXAMPLE 9a

### Comparative

75.2 grams of a polyacrylic acid (ALCOSPERSE 602A from Alco Chemical) and 12.4 grams of triethanol amine (TEA) and 12.4 grams of water was mixed to form a homogenous solution.

### EXAMPLE 9b

### Comparative

75.2 grams of a polyacrylic acid (ALCOSPERSE 602A from Alco Chemical) and 12.4 grams of TEA and 5.0 grams of sodium hypophosphite and 7.4 grams of water was mixed to form a homogenous solution.

### EXAMPLE 10

A reactor containing 300 grams of water was heated to 95 C. A monomer solution containing 200 grams of acrylic acid and 100 grams of hydroxypropylacrylate was added to the reactor over a period of 2 hours. An initiator solution comprising of 9 grams of sodium persulfate in 60 grams of deionized water was simultaneously added to the reactor over a period of 2 hours and 15 minutes. The reaction product was held at 95 C for 2 additional hours.

### EXAMPLE 11

A reactor containing 300 grams of water was heated to 95 C. A monomer solution containing 240 grams of acrylic acid and 60 grams of hydroxypropylacrylate was added to the reactor over a period of 2 hours. An initiator solution comprising of 9 grams of sodium persulfate in 60 grams of deionized water was simultaneously added to the reactor over a period of 2 hours and 15 minutes. The reaction product was held at 95 C for 2 additional hours.

### EXAMPLE 12

The testing protocol was as follows: 20 grams of each of these solutions were poured into poly(methylpentene) (PMP) petri dishes and placed overnight in a forced air oven set at 60° C. They were then cured by being placed for 10 minutes in a forced air oven set at 150° C. After cooling, the resulting films were evaluated in terms of physical appearance, flexibility, and tensile strength.

TABLE 1

| SAMPLE | | AP- | FLEXI- | |
|---|---|---|---|---|
| # (H12-VIII) | COMPOSITION | PEARANCE | BILITY | TENSILE |
| Example 9a | 602A-HS/TEA | “Swiss | Low flex, | Breaks |
| (Comparative) | | cheese”, | breaks | readily |
| | | yellow- | easily | |
| | | brown | | |
| | | color | | |
| Example 9b | Polyacrylic | “Swiss | Slight | Stretches, |
| (comparative) | acid/triethanol | cheese”, | flexi- | tensile |
| | amine/sodium | slight | bility, | slightly |
| | hypophosphite | yellowing, | breaks | stronger |
| | | | easily | than |
| | | | | Control |
| Example 10 | PAA/30% HPA | Very Clear | Forgiving | Very |
| | | colorless | when | strong |
| | | film | bent, very | |
| | | | stiff | |
| Example 11 | PAA/20% HPA | Very Clear | Forgiving | Very |
| | | colorless | when | strong |
| | | film | bent, very | |
| | | | stiff, | |
| | | | does not | |
| | | | shatter | |
| | | | when | |
| | | | broken | |

### EXAMPLE 13

### Example of a Carboxybetaine

A reactor containing 200 grams of water and 244 grams of isopropanol was heated to 85° C. A monomer solution containing 295 grams of acrylic acid and 5 grams of 4-vinylpyridine was added to the reactor over a period of 3.0 hours. An initiator solution comprising of 15 grams of sodium persulfate in 100 grams of deionized water was simultaneously added to the reactor over a period of 3.5 hours. The reaction product was held at 85° C. for an additional hour. The isopropanol was then distilled using a dean Stark trap. The vinylpyridine moiety was then functionalized to the carboxy betaine by reaction with sodium chloroacetate at 95 C for 6 hours.

### EXAMPLE 14

### Example of a Sulfobetaine

A reactor containing 200 grams of water and 244 grams of isopropanol was heated to 85° C. A monomer solution containing 295 grams of acrylic acid and 5 grams of 4-vinylpyridine was added to the reactor over a period of 3.0 hours. An initiator solution comprising of 15 grams of sodium persulfate in 100 grams of deionized water was simultaneously added to the reactor over a period of 3.5 hours. The reaction product was held at 85° C. for an additional hour. The isopropanol was then distilled using a dean Stark trap. The vinylpyridine moiety was then functionalized to the sulfobetaine by reaction with sodium chlorohydroxypropane sulfonate at 100 C for 6 hours.

### EXAMPLE 15

### Example of a Polymer with a Quaternized Amine Comonomer

A reactor containing 200 grams of water and 244 grams of isopropanol was heated to 85° C. A monomer solution containing 290 grams of acrylic acid and 10 grams of diallyldimethylammonium chloride was added to the reactor over a period of 3.0 hours. An initiator solution comprising of 15 grams of sodium persulfate in 100 grams of deionized water was simultaneously added to the reactor over a period of 3.5 hours. The reaction product was held at 85° C. for an additional hour. The isopropanol was then distilled using a dean Stark trap.

What is claimed is:

1. A non-woven binder composition, comprising an aqueous solution of a copolymer binder comprising:
a) at least one acid functional monomer unit; and
b) at least one hydroxyl, amide, or amine monomer unit.

2. The binder composition of claim 1 wherein said copolymer binder comprises:
a) from 1 to 99 mole percent of said acid functional monomer unit; and
b) from 1-75 mole percent of said amide, amine or hydroxyl functional monomer unit.

3. The binder composition of claim 1 wherein said copolymer binder comprises from 50 to 95 mole percent of said acid functional monomer.

4. The binder composition of claim 1 wherein said acid functional monomer is selected from the group consisting of a carboxylic acid monomer, a phosphonic acid monomer, a sulfonic acid monomer, or a mixture thereof.

5. The binder composition of claim 4 wherein said carboxylic acid monomer comprises acrylic acid, methacrylic acid, maleic acid or a mixture thereof.

6. The binder composition of claim 1 wherein said hydroxyl, amide, or amine monomer unit comprises a sulfobetaine or carboxybetaine.

7. The binder composition of claim 1 wherein said copolymer binder comprises 10 to 20 mole percent of said amine, amide, or hydroxyl functional monomer.

8. The binder composition of claim 1 wherein said copolymer binder comprises the acid functional monomer and amine or hydroxyl functional monomer in a mole ratio of from 100:1 to 1:1.

9. The binder composition of claim 1 wherein said copolymer binder further comprises up to 50 mole percent of non-functional ethylenically unsaturated monomer units.

10. The binder composition of claim 1, wherein said copolymer binder has a molecular weight of from 1,000 to 300,000.

11. The binder composition of claim 1 wherein said binder composition further comprises from 0 to 25 weight percent of at least one catalyst, based on the weight of the copolymer binder.

12. A binder composition comprising an aqueous solution comprising:
a) a poly copolymer binder comprising at least one acid functional monomer unit; and
b) a polyamine or amide-amine crosslinking agent.

13. The binder composition of claim 12 wherein said polyamine or amide-amine crosslinking agent contains no hydroxy groups.

14. The binder composition of claim 12 wherein said crosslinking agent is selected from the group consisting of diethylenetriamine, tetraethylenepentamine, polyathyleneimine, and mixtures thereof.

15. A bonded non-woven mat comprising an a fibrous substrate having directly deposited thereon a copolymer binder, wherein said copolymer binder comprises:
a) at least one acid functional monomer unit; and
b) at least one hydroxyl, amide, or amine functional monomer unit.
